(19) United States
(12) Patent Application Publication
(10) Pub. No.: US 2025/0289979 A1
(43) Pub. Date: Sep. 18, 2025

(54) BIO-BASED SEALING COMPOSITION, WOOD PRODUCT COMPRISING THE SAME AND APPLICATIONS THEREOF

(71) Applicant: NANO AND ADVANCED MATERIALS INSTITUTE LIMITED, HONG KONG (CN)

(72) Inventors: Lei GAO, HONG KONG (CN); Yimu YUAN, HONG KONG (CN); Suping BAO, HONG KONG (CN)

(73) Assignee: NANO AND ADVANCED MATERIALS INSTITUTE LIMITED, HONG KONG (CN)

(21) Appl. No.: 18/605,681

(22) Filed: Mar. 14, 2024

(51) Int. Cl. C09D 191/06; B05D 7/06; C09D 7/40; C09D 193/00

(52) U.S. Cl. CPC C09D 191/06; B05D 7/06; C09D 7/40; C09D 193/00

(57) ABSTRACT

The present disclosure provides a bio-based sealing composition for imparting waterproof performance to a wood substrate, a wood product comprising the composition, and the applications thereof. The sealing composition comprises a paraffin wax, bio-based wax, penetration aid, structural modifier, and optionally a functional additive. As compared with commercial sealing wax compositions, the bio-based sealing composition of the present disclosure shows better waterproof, reduced substrate surface friction, lower volume shrinkage, and superior durability.

### BACKGROUND

### Technical Field

The present disclosure particularly relates to a bio-based sealing composition for imparting waterproof performance to a wood substrate, a wood product comprising the sealing composition, and the applications of the bio-based sealing composition.

### Description of Related Art

The flooring industry has developed easy-to-install wood flooring that is easy to lock together with jointing the components with the tongue and groove joint. Such flooring can be made from hardwoods, laminates, or engineered wood products. The wooden material of flooring is porous, and moisture may penetrate the material to cause damage by swelling and promoting microbial degradation. Therefore, preventing water penetration into the wooden substrates is important to prolong the life of wood flooring.

Generally, wood flooring needs to be protected and sealed with a sealer during production. Sealing wax is commonly used between the floor tongue and groove joint connection assembly to impart water and moisture resistance to wood floors.

Conventionally, petroleum-based sealing wax is used as sealing wax. Under heating, the molten petroleum-based sealing wax can be coated on the tongue-and-groove surface of the wood floor by automated sealing wax equipment. When cooled to room temperature, a uniform wax layer can then be formed, which can be a protective layer to protect the wood floor from water or moisture.

Nevertheless, there are several problems with the current petroleum-based sealing wax.

The most serious problem is its inferior water/moisture-resistance performance. Water-proofing problems are the main issues for the wood floor since the humid environment always exists, particularly in Southeast Asia, and soaking, swelling, and even bending of the wood floor would therefore take place. The reason for such poor sealing performance is owing to the property of paraffin itself.

Another problem is the non-renewability of conventional sealing wax products. As a petroleum-based product, petroleum-based sealing wax is the most used sealing wax. In other words, the conventional sealing wax is completely non-renewable. Nowadays, it is the goal to develop renewable ‘green’ products to promote sustainable development.

In addition, a good sealing wax can also reduce the friction between the joint part of two parts of the floor, which not only facilitates the reduction of wax loss during installation but also facilitates the reduction of noise generated by friction between wooden floors.

In recent years, renewable bio-based materials are emerging to partially or completely replace petroleum-based materials, due to the environment and limited natural resources consideration. Environmental impacts such as reduced carbon dioxide emissions are one of the key driving forces for using more ‘green’ raw materials such as bio-based materials. Paraffin is a typical petroleum-based material, and the production and application of paraffin may cause certain environmental problems including an increase in carbon dioxide emission. Therefore, it is a good opportunity to develop novel sealing products based on renewable bio-based materials to gradually replace conventional petroleum-based materials.

In summary, it is necessary to develop a new bio-based sealing composition for wood product that is environmentally friendly and cost-effective and imparts significant waterproof performance to the wood product.

### SUMMARY

In order to solve the above technical problems, the inventors of the present disclosure propose a new bio-based sealing wax formulation, which is prepared by partially replacing a petroleum-based wax with a renewable green bio-based wax. The obtained sealing wax formulation not only provides better waterproof performance for wood substrate and reduces adverse effects of water vapor on the wood substrate, but also reduces the friction between the joint parts of the wood product during installation.

As a first aspect of the present disclosure, provided is a sealing composition comprising, based on the total weight of the sealing composition:
15%-55% of one or more paraffin waxes selected from the group consisting of a crude paraffin, semi-refined paraffin, all-refined paraffin, and mixtures thereof;
5%-50% of one or more bio-waxes selected from the group consisting of soy wax, beeswax, candelilla wax, rice bran wax, carnauba wax, and mixtures thereof;
10%-50% of one or more penetration aids selected from the group consisting of paraffin oil, isoparaffin, soybean oil, oleic acid, soft wax, and mixtures thereof; and
0%-40% of one or more structural modifiers selected from the group consisting of a microcrystalline wax, petroleum resin, terpene resin, and mixtures thereof.

As a second aspect of the present disclosure, provided is a wood product comprising a wood substrate and a wax layer formed from the sealing composition according to the first aspect on at least a part of the surface of the wood substrate.

As a third aspect of the present disclosure, provided is a method for treating a wood substrate, comprising a step of applying the sealing composition according to the first aspect to at least a part of the surface of the wood substrate to form a wax layer.

The present disclosure provides an environmentally friendly and cost-effective sealing wax composition capable of imparting desired waterproof performance to the wood product. Particularly, the sealing composition of the present disclosure is hydrophobic blends that can be melted by heating and applied to an edge, e.g., tongue-and-groove, surface of the wood substrate.

When the sealing composition cools to a temperature lower than its melting point, e.g., room temperature, it will form a wax layer on the surface of the wood substrate, and the formed wax layer can reduce water absorption and thickness swelling of the wood substrate during storage, transit, or installation or after installation. As compared with commercial sealing wax compositions, the sealing composition of the present disclosure shows better waterproof, lower volume shrinkage, and superior durability. The present sealing composition also provides lubricity to the edges of the wood substrate, which can facilitate installation, particularly where the wood substrate is designed with complementary geometries that are profiled to be interlocked with the edges of adjacent boards. The present sealing composition further provides sound dampening by reducing friction between adjacent wood products such as floorboards. Furthermore, the use of the bio-based waxes in the sealing composition provides environmentally friendly and sustainable advantages.

### BRIEF DESCRIPTION OF THE DRAWINGS

The accompanying drawings are included to provide a further understanding of the disclosure and are incorporated in and constitute a part of this specification. The drawings described herein are for illustration purposes only and are not intended to limit the scope of the disclosure in any way.

FIG. 1 illustrates the general procedure for formulating the sealing composition of the present disclosure.

FIG. 2 illustrates the steps of a waterproof test used to evaluate the sealing composition of the present disclosure.

FIG. 3 shows the appearance (front view) of the wax layers formed from the sealing composition of Embodiment 1 in Example 1 and from a commercial product (control) before and after the water immersion test.

FIG. 4 shows the appearance (side view) of the wax layers formed from the sealing composition of Embodiments 1, 4 and 5 (from left to right) in Example 1 after the additional water immersion test in Example 3.

FIG. 5 shows Fourier transform infrared spectrograms of the sealing composition of Embodiment 1 in Example 1 and a commercial product (control).

### DESCRIPTION OF THE EMBODIMENTS

The following detailed description is merely exemplary in nature and is in no way intended to limit the present disclosure or its application or uses.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The terminology used herein is for the purpose of describing particular example embodiments only and is not intended to be limiting.

As used herein, “a”, “an”, “the”, “at least one” and “one or more” are used interchangeably to indicate that at least one of the specified elements, materials, ingredients or method steps is present, unless the context clearly indicates otherwise.

As used herein, the terms “about” and “substantially” are used herein with respect to measurable values and ranges due to expected variations known to those skilled in the art (e.g., limitations and variability in measurements). The term “about” also indicates that the stated numerical value allows some slight imprecision (with some approach to exactness in the value;

approximately or reasonably close to the value; nearly). If the imprecision provided by the term “about” is not otherwise understood in the art with this ordinary meaning, then the term “about” as used herein indicates at least variations that may arise from ordinary methods of measuring and using such parameters. In addition, disclosure of ranges includes disclosure of all values and further divided ranges within the entire range.

As used herein, the term “including”, “containing” and like terms, together with their grammatical variations, are synonymous with the term “comprising” and its grammatical variations. The term “comprising” and its grammatical variations are open-ended and shall be understood in the context of the present disclosure to include not only the specified elements, materials, ingredients or method steps, but also additional unspecified elements, materials, ingredients or method steps.

As used herein, the term “consisting of” and its grammatical variations should be understood in the context of the present disclosure to exclude the presence of any unspecified element, ingredient or method step. As used herein, the term “consisting essentially of” and its grammatical variations should be understood in the context of the present disclosure to include the specified elements, materials, ingredients or method steps and those that do not materially affect the basic and novel characteristic(s)” of what is being described. It shall be understood that, when the term “comprising” and its grammatical variations are used and no additional elements, materials, ingredients or method steps that may materially affect the basic and novel characteristic(s)” of what is being described are included, then the term “comprising” can be replaced with the term “consisting of” or “consisting essentially of” and their grammatical variations.

Whereas specific aspects of the disclosure is going to be described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

As mentioned above, the present disclosure is aimed to provide a sealing composition which shows better waterproof performance, further reduction of substrate surface friction, lower volume shrinkage, and superior durability.

As a first aspect of the present disclosure, provided is a sealing composition comprising, based on the total weight of the sealing composition:
15%-55% of one or more paraffin waxes selected from the group consisting of a crude paraffin, semi-refined paraffin, all-refined paraffin, and mixtures thereof;
5%-50% of one or more bio-waxes selected from the group consisting of soy wax, beeswax, candelilla wax, rice bran wax, carnauba wax, and mixtures thereof;
10%-50% of one or more penetration aids selected from the group consisting of paraffin oil, isoparaffin, soybean oil, oleic acid, soft wax and mixtures thereof; and
0%-40% of one or more structural modifiers selected from the group consisting of a microcrystalline wax, petroleum resin, terpene resin, and mixtures thereof.

### Paraffin Wax

The term “paraffin wax” or “paraffin” refers to a petroleum-based wax, that is, such wax is produced from petroleum-based materials.

In a particular embodiment, the paraffin wax may be present in an amount from about 25% to about 55% by weight, based on the total weight of the sealing composition. For example, it may be present at an amount of about 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, or 55% by weight, or in any range composed of the above numbers, based on the total weight of the sealing composition.

In a preferred embodiment, the paraffin wax may be present in an amount from about 30% to about 45% by weight, based on the total weight of the sealing composition.

In a more preferred embodiment, the paraffin wax may be present in an amount from about 40% to about 45% by weight, based on the total weight of the sealing composition.

In a particular embodiment, the paraffin wax has a melting point from about 40° C. to about 85° C.

In a preferred embodiment, the paraffin wax has a melting point from about 50° C. to about 65° C.

In a preferred embodiment, the paraffin wax in the sealing composition may be crude paraffin, for example, it may be No. 56, No. 58, No. 60 or No. 62 crude paraffin.

In a more preferred embodiment, the paraffin can be No. 58 crude paraffin wax with a melting point of approximately 57° C. to 60° C.

### Bio-Wax

In the present disclosure, the bio-wax in the sealing composition can be hydrocarbon wax, for example, animal wax (e.g., beeswax) or vegetable wax (e.g., soy wax, candelilla wax, rice bran wax or carnauba wax), whose raw material is renewable. The bio-wax has a certain active functional group, e.g., a hydroxy group, that can form hydrogen bonds with the wood substrate. The bio-wax improves the adhesion to the wood substrate and in turn enhances the durability of the sealing wax.

In a particular embodiment, the bio-wax may be present in an amount from about 15% to about 25% by weight, based on the total weight of the sealing composition. For example, it may be at an amount of about 15%, 16%, 17%, 18%, 19%, 20%, 21%, 22%, 23%, 24% or 25% by weight, or in any range composed of the above numbers, based on the total weight of the sealing composition.

In a preferred embodiment, the bio-wax may be present in an amount from about 15% to about 20% by weight, based on the total weight of the sealing composition.

In a particular embodiment, the bio-wax is solid at room temperature (i.e., about 25° C.) and can be fully melted at a temperature at or below 120° C. but above its melting point.

In a preferred embodiment, the bio-wax has a melting point from about 55° C. to about 85° C.

In a more preferred embodiment, the bio-wax has a melting point from about 60° C. to about 70° C.

In a preferred embodiment, the bio-wax may be a soy wax and/or a beeswax.

In a more preferred embodiment, the bio-wax may be No. 68 soy wax with a melting point of about 68° C. to about 70° C., and/or a beeswax with a melting point of about 65° C. to about 70° C.

### Penetration Aid

In the present disclosure, the penetration aid is a non-volatile liquid with a certain fluidity at room temperature, which is added into the sealing composition of the present disclosure to provide permeability.

In a particular embodiment, the penetration aid may be present in an amount from about 10% to about 40% by weight, based on the total weight of the sealing composition. For example, it may be at an amount of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% by weight, or in any range composed of the above numbers, based on the total weight of the sealing composition.

In a preferred embodiment, the penetration aid may be present in an amount from about 25% to about 30% by weight, based on the total weight of the sealing composition.

In a particular embodiment, the penetration aid is in a liquid state at room temperature (i.e., about 25° C.) and has a viscosity of 5 cSt to 10000 cSt, preferably 5 cSt to 1000 cSt. The suitable viscosity is related to the flow and penetration abilities of the wax into the wood substrate. Too low a viscosity can lead to rapid penetration of a single component and phase separation from other components of the sealing wax, while too high a viscosity is not conducive to improving the penetration properties of the sealing wax.

In a particular embodiment, the penetration aid is paraffin oil, soybean oil, isoparaffin, oleic acid or soft wax.

In a preferred embodiment, the penetration aid may be paraffin oil with a viscosity of 26 cSt at room temperature.

In a particular embodiment, the penetration aid may have a boiling point of over 100° C.

In a preferred embodiment, the penetration aid may be paraffin oil comprising saturated hydrocarbon chains of 10 to 25 carbons.

### Structural Modifier

The inventors found that crystallization behavior of some components in the sealing composition may cause some cracking defects during the application of the sealing composition to the wood substrate, and thus it is necessary to add an amount of the structural modifiers for eliminating this phenomenon.

In the context of the present disclosure, the structural modifier in the sealing composition of the present disclosure can also be called as crystal modifier, which is added to change and stabilize the structure.

In a particular embodiment, the structural modifier may be present in an amount from about 10% to about 25% by weight, based on the total weight of the sealing composition. For example, it may be at an amount of about 10%, 11%, 12%, 13%, 14%, 15%, 16%, 17%, 18%, 19%, 20%, 21%, 22%, 23%, 24% or 25% by weight, or in any range composed of the above numbers, based on the total weight of the sealing composition.

In a preferred embodiment, the structural modifier may be present in an amount from about 10% to about 15% by weight, based on the total weight of the sealing composition.

In a particular embodiment, the structural modifier may have a melting point above 50° C.

In a preferred embodiment, the structural modifier may have a melting point from about 50° C. to about 105° C.

In a preferred embodiment, the structural modifier may be microcrystalline wax with a melting point from about 60° C. to about 85° C., e.g., from about 60° C. to about 80° C.

The inventors found that the microcrystalline wax with a melting point from about 60° C. to about 80° C. could reduce crystallinity of the sealing composition to stabilize the structure, and also increase toughness of the sealing composition and reduce mass loss of the sealing composition under environmental conditions to improve the durability of the sealing composition.

In a more preferred embodiment, the structural modifier may be a mixture of microcrystalline wax and terpene resin, or a mixture of microcrystalline wax and petroleum resin.

### Functional Additives

In the context of the present disclosure, the sealing composition of the present disclosure may further comprise one or more functional additives, which may be, but are not limited to a thickener, fungicide, biocide, mildewcide, dispersant, surfactant, wetting agent, hindered amine light stabilizer, ultraviolet radiation absorber, film former, adhesive, or combinations thereof. Those skilled in the art can select the suitable functional additive(s) for the sealing composition according to the actual needs.

### Sealing Composition

The term “sealing composition” as used herein is interchangeable with the expression “sealing wax” or “sealing wax formulation”. The sealing composition is in a waxy solid state at room temperature and will be in a fluid state when it is heated at a temperature above its melting point. The sealing composition, when in a fluid state, can be applied to the wood substrate by a method known in the art.

The sealing composition can melt without decomposing. Thus, the sealing composition can be melted by heating at a temperature above its melting point for application to a wood substrate, and re-solidify upon returning to room temperature. The sealing composition may be completely melted to a homogeneous liquid for application to a wood substrate, and remain a liquid until at least it contacts the wood substrate.

The melting point of the sealing composition is a function of its penetration and surface wax layer formation properties. In general, the melting point of the sealing composition should be sufficiently above the room temperature such that the composition remains solid after it is applied to the wood substrate. If the melting point is too low, the sealing composition will immediately penetrate the wood substrate such as the wood floor and may soften or degrade the resin binder and/or resin-cellulose interface. This degradation may enhance rather than impede the penetration of water into the wood product and cellulose fibers. On the other hand, if the melting point is too high, the sealing composition may solidify on the application equipment (e.g., tubes or nozzles) before it is applied to the wood substrate. The sealing composition, when applied to the substrate, must be in a liquid state, and thus the sealing composition should be heated to a temperature above its melting point before application.

The melting point of the sealing composition of the present disclosure can be adjusted by the selection of the wax components and their amounts. For example, the melting point can be lowered so as to mitigate any clumping or solidification issues associated with the application during production. In some embodiments, the melting point of the sealing composition can be adjusted by changing the amount of the penetration aid(s) or the structural modifier(s).

In a particular embodiment, the sealing composition of the present disclosure has a melting point from about 40° C. to about 80° C.

The sealing composition of the present disclosure can be prepared by melting and mixing the above-mentioned individual components at a suitable temperature, at which the individual components do not evaporate, decompose, or react with each other. The sealing composition in a liquid state will become a solid once it is cooled to a temperature lower than the melting point, e.g., room temperature.

In a particular embodiment, the sealing composition of the present disclosure is prepared by melting the paraffin wax, the bio-wax, the penetration aid, the structural modifier, and optionally the functional additives at a temperature from about 60° C. to about 150° C. to a liquid state.

In a more particular embodiment, the sealing composition may be prepared by heating the individual components at a temperature from about 70° C. to about 120° C., e.g., from about 70° C. to about 90° C.

The sealing composition can be applied to the wood substrate by any method known in the art. For example, the sealing composition can be applied by spraying, wiping, or brushing with some equipment.

When applied to the wood substrate, e.g., wood-based floor, the sealing composition of the present disclosure can impart waterproofing and dampen sound.

As a second aspect of the present disclosure, provided is a wood product comprising a wood substrate and a wax layer formed from the sealing composition according to the first aspect on at least a part of the surface of the wood substrate.

In a particular embodiment, the wax layer is formed on an edge surface of the wood substrate.

In a more particular embodiment, the wax layer is formed on a tongue-and-groove surface of the wood substrate.

In a particular embodiment, the sealing composition further penetrates the wood substrate, for example, the edges of the wood substrate. In this way, the sealing composition of the present disclosure provides deeper coverage protection while forming a uniformly thin wax layer on the edge surface of the wood substrate.

In a more particular embodiment, the sealing composition penetrates the tongue-and-groove of the wood substrate.

It should be note that, if too much of the sealing composition is applied to the joint edges, problems will occur with the splicing of adjacent boards. If too little of the sealing composition is applied, the thickness will not be sufficient to provide good protection. Thus, in a particular embodiment, the sealing composition forms on the wood substrate a uniformly dense thin wax layer. The thickness of the thin wax layer should be well controlled to ensure the good protection for the wood substrate without affecting the interlock between the edges of adjacent boards.

In a particular embodiment, the wood product may be, but is not limited to, trim, furniture, subflooring, wall coverings or wood floor such as laminate floor.

As compared with conventional petroleum-based sealing wax products, the wood product of the present disclosure as defined above shows better waterproof, further reduction of substrate surface friction, lower volume shrinkage, and superior durability. Thus, the present disclosure may provide an efficient, economical, and environmentally friendly sealing wax product.

As a third aspect of the present disclosure, provided is a method for treating a wood substrate, comprising a step of applying the sealing composition according to the first aspect to at least a part of the surface of the wood substrate to form a wax layer.

As described above, the sealing composition of the present disclosure may be applied to the wood substrate by any method known in the art. For example, the sealing composition may be applied by spraying, wiping, or brushing with some equipment.

In a particular embodiment, the sealing composition may be applied to an edge surface of the wood substrate to form a wax layer.

In a more particular embodiment, the sealing composition may be applied to a tongue-and-groove surface of the wood substrate to form a wax layer.

As described above, the sealing composition may be applied to the tongue-and-groove surface of the wood substrate, so as to yield a wax layer that substantially reduces water absorption and thickness swelling of the wood substrate during storage, transit, or installation or after installation. The present sealing composition also provides lubricity to the edges of the wood substrate, which facilitates installation, particularly where the wood substrate is designed with complementary geometries that are profiled to be interlocked with the edges of adjacent boards.

In a particular embodiment, the wax layer formed from the sealing composition on the wood substrate is a uniformly dense thin wax layer, so as to impart waterproofing and dampen sound.

In a particular embodiment, the wood substrate may be, but is not limited to, trim, furniture, subflooring, wall coverings, or wood floor such as laminate floor.

### EXAMPLES

Within this specification, examples have been described in a way which enables a clear and concise specification to be written, but it is intended and will be appreciated that examples may be variously combined or separated without parting from the disclosure. For example, it will be appreciated that all preferred features described herein are applicable to all aspects of the disclosure described herein.

### Example 1: Preparation of the Sealing Composition

The general procedure for preparing the sealing composition of the present disclosure is as follows. Firstly, the bio-based wax and the petroleum-based wax (paraffin) are softened at 90° C. for 20 min to gain a solid-liquid mixture with certain fluidity. Then the solid-liquid mixture is stirred at 90° C. with a 200-rpm stirring paddle for 60 min to obtain a first homogeneous molten wax. After that, the additive(s) is/are added and softened at 90° C. for 20 min, and then stirred at 90° C. with a 200-rpm stirring paddle for 60 min to obtain a second homogeneous molten wax. Then, the second homogeneous molten wax is cooled and solidified at room temperature (i.e., about 25° C.) to obtain a sealing wax product.

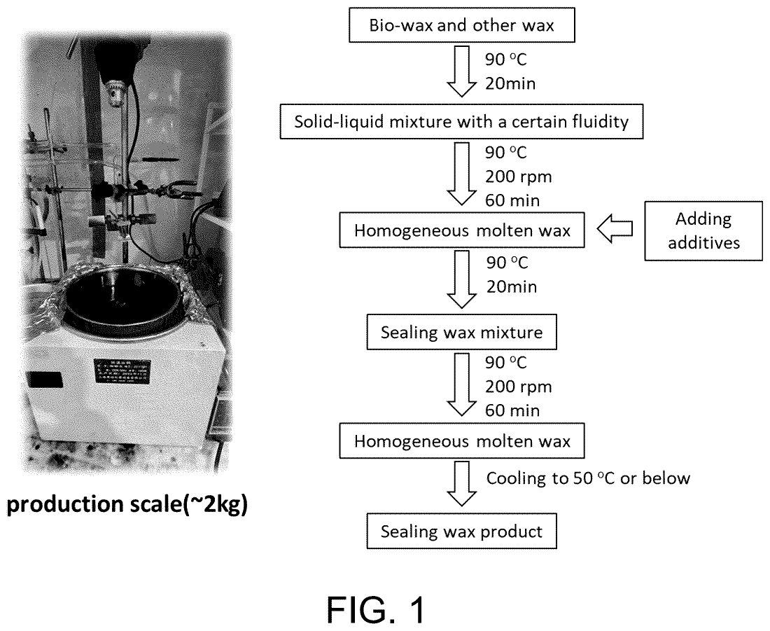

FIG. 1 illustrates the general procedure for formulating the sealing composition of the present disclosure.

The embodiments of the sealing compositions were prepared according to the above-described procedure and provided in the following Table 1. As used herein, the crude paraffin wax is No. 58 crude paraffin wax (58 #) with a melting point of about 57° C. to about 60° C.; the soy wax is No. 68 soy wax (68 #) with a melting point of about 68° C. to about 70° C.; the beeswax has a melting point of about 65° C. to about 70° C.; the microcrystalline wax has a melting point of about 70° C. to about 75° C.; the soft wax has a melting point of about 45° C. to about 48° C.; and the viscosity of paraffin oil is 26 cSt at room temperature.

TABLE 1
The embodiments of the sealing compositions (the components are given by weight)

| Embodiments | | 1 | 2 | 3 | 4 | 5 | 6 | 7 | 8 |
|---|---|---|---|---|---|---|---|---|---|
| Paraffin | crude paraffin | 58#, | 58#, | 58#, | 58#, | 58#, | | | 58#, |
| | | 43.5% | 43.5% | 40% | 41.7% | 41.7% | | | 47.6% |
| | semi-refined | | | | | | 58#, | | |
| | paraffin | | | | | | 43.5% | | |
| | all-refined | | | | | | | 60#, | |
| | paraffin | | | | | | | 28.6% | |
| Bio-wax | soy wax | 68#, | | | 68#, | 68#, | 68#, | 58#, | 68#, |
| | | 17.4% | | | 16.7% | 16.7% | 17.4% | 19% | 9.5% |
| | beeswax | | 17.4% | 20% | | | | | |
| | rice bran wax | | | | | | | | |
| | carnauba wax | | | | | | | | |
| penetration | paraffin oil | 26#, | 26.1% | | 25% | 25% | 26#, | 32#, | 26#, |
| aid | | 26.1% | | | | | 26.1% | 47.6% | 28.6% |
| | isoparaffin | | | | | | | | |
| | soybean oil | | | | | | | | 9.5% |
| | oleic acid | | | | | | | | |
| | soft wax | | | 40% | | | | | |
| Structural | microcrystalline | 70#, | 70#, | | 70#, | 70#, | 70#, | #70, | 70#, |
| modifier | wax | 13% | 13% | | 12.5% | 12.5% | 13% | 4.8% | 4.8% |
| | petroleum resin | | | | 4.1% | | | | |
| | terpene resin | | | | | 4.1% | | | |
| Embodiments | | 9 | 10 | 11 | 12 | 13 | 14 | 15 | 16 |
| Paraffin | crude paraffin | 58#, | 58#, | 58#, | 58#, | 58#, | 58#, | 58#, | 58#, |
| | | 43.5% | 52.6% | 25% | 41.7% | 33.3% | 17.4% | 43.5% | 43.5% |
| | semi-refined | | | | | | | | |
| | paraffin | | | | | | | | |
| | all-refined | | | | | | | | |
| | paraffin | | | | | | | | |
| Bio-wax | soy wax | 68#, | | | 68#, | 68#, | 68#, | | |
| | | 8.7% | | | 16.7% | 16.7% | 17.4% | | |
| | beeswax | | 21.1% | 50% | | | | | |
| | rice bran wax | | | | | | | 17.4% | |
| | carnauba wax | | | | | | | | 17.4% |
| penetration | paraffin oil | | 26#, | | 26#, | | 26#, | 26#, | 26.1% |
| aid | | | 10.5% | | 25% | | 26.1% | 26.1% | |
| | isoparaffin | 26.1% | | | | | | | |
| | soybean oil | | | | | | | | |
| | oleic acid | 8.7% | | | | | | | |
| | soft wax | | | 25% | | 33.3% | | | |
| Structural | microcrystalline | | 70#, | | 70#, | 70#, | 70#, | 70#, | 70#, |
| modifier | wax | | 15.8% | | 12.5% | 8.3% | 39.1% | 13% | 13% |
| | petroleum resin | | | | | 4.2% | | | |
| | terpene resin | | | | 4.2% | | | | |

### Example 2: Performance Tests of the Sealing Compositions

After the sealing compositions were prepared in accordance with the procedure in Example 1, the sealing compositions were tested for various performances, including thickness swelling, water absorption, volume shrinkage, melting point, microstructure and Coefficient of Friction.

### Thickness Swelling Test:

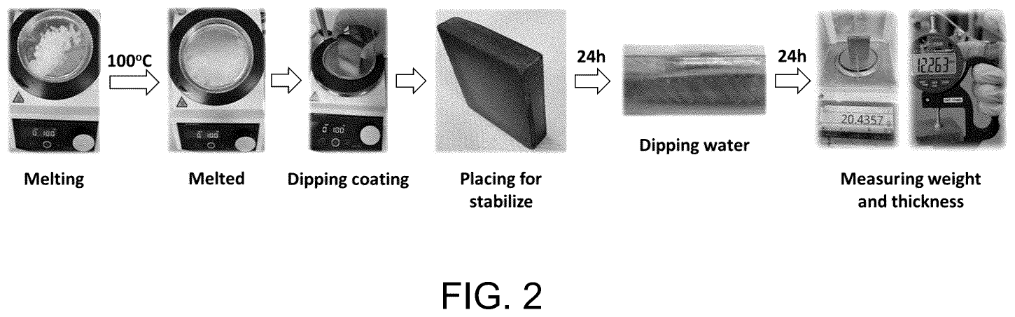

The thickness swelling is a measure of waterproof performance of the sealing composition in terms of standards ASTM 1037 or GB/T 1934. The general procedure for the thickness swelling test is as follows. Firstly, the sealing composition is melted at 100° C. to a liquid state and then coated (using the dip coating method) uniformly on the surface of small wooden blocks (5×5×1 cm) to prepare the test samples, and the test samples are placed at room temperature for 24 h to reach stability. After the thickness is measured, the test samples are completely immersed into a container with ultrapure water, and then the container is covered to prevent water loss. After a certain duration of immersion, the test samples are removed from the container, and the surface water is absorbed with absorbent paper. Finally, the thickness of the test samples is recorded. FIG. 2 illustrates the steps of the above-mentioned general procedure for evaluating thickness swelling (also for water absorption).

The percent thickness swelling of a wood floor coated with a sealing composition is as follows:

$$thickness swelling , \% = ( ( {t}_{2} - {t}_{1} ) / {t}_{1} ) \times 100 \%$$

where:
t₁=the thickness of the test sample before water immersion;
t₂=the thickness of the test sample after water immersion for 24 hours.

### Water Absorption Test:

Water absorption is a measure of surface cure time in terms of standards ASTM 1037 or GB/T 1934. The experimental procedure is essentially the same as that for thickness swelling test, with the sample mass measured before and after water immersion.

The percent thickness swelling of the wood floor coated with a sealing composition is as follows:

$$water absorption , \% = ( ( {m}_{2} - {m}_{1} ) / {m}_{1} ) \times 100 \%$$

where:
m₁=the mass of the test sample weighted before water immersion;
m₂=the mass of the test sample weighted after water immersion for 24 hours.

### Volume Shrinkage Test:

The volume shrinkage test was performed following standard ASTM D1168 or SH/T 0588. The general procedure for the volume shrinkage test is as follows. Firstly, the forming cylinder is fixed in a constant temperature water bath (70° C.±2° C.) and submerged to a depth of not less than the 100 mL mark of the forming cylinder. Then the melted specimen (here is the sealing composition of the present disclosure) is poured into the forming cylinder and adjusted exactly to the 100 mL mark. After the specimen is stabilized, the temperature of the water bath is reduced to 40° C. to cool the specimen. After the specimen in the forming cylinder has solidified, a glass rod with a tapered end is passed through the center of the thin layer of wax into the cavity to form an open hole. After stabilization in a constant temperature water bath at a melting point of 40° C. for 2 h, a solution of 50% (V/V) aqueous glycerol is taken with a 25 mL burette and dropped into the forming cylinder to the 100 mL mark. Then, the molding cylinder is evacuated with a vacuum pump to remove the air from it. Then 50% (V/V) glycerol solution is added to the forming cylinder to 100 mL. The step is repeated until there are no more air bubbles in the forming cylinder and the level of the aqueous glycerol solution remained at the 100 mL mark. The volume of glycerol solution consumed is recorded.

The percent volume shrinkage of the sealing composition is calculated as follows:

$$volume shrinkage , \% = ( V / 100 ) \times 100 \%$$

where:
V=the volume of the aqueous glycerol solution consumed, mL.

The volume shrinkage of the sealing composition during phase change can cause the sealing composition to develop structural defects after coating, which affects its waterproof performance.

### Melting Point Test:

The melting point test was carried out according to ISO 3841. Since there is a broad temperature range for melting the sealing composition, the melting point of the sealing composition was measured using an auto melting point apparatus, and the melting point was determined accurately when the sealing composition completely became liquid. In the melting point test, a very small amount (less than 1 mg) of the sealing composition sample was used for testing. To characterize the melting state in practical applications, we proposed a support method to further characterize the melting point. The sealing composition (less than 10 g) was melted by the method of water bath heating, and the melting state of the sealing composition was observed and recorded when the temperature gradually increased. The melting point test was carried out under standard conditions (room temperature and 50-60% RH).

### Microstructure:

The microstructure of the sealing composition was assessed by a Fourier-Transform Infrared Spectroscopy analysis (FTIR), which was performed in the Nicolet iS50 FTIR Spectrometer (Thermo Fisher Scientific, USA). Every sealing composition sample was examined in mid-infrared from 4000 to 500 cm-1, using 32 scans and 1 cm-1 of resolution.

### Coefficient of Friction:

The friction coefficient test was carried out under standard conditions (room temperature and 50-60% RH) according to ASTM 1894 or GB/T 10006. The coefficient of friction tester was used to test the friction coefficient of the sealing composition on medium density fiberboard. In this case, the test sample speed was set up as 150 mm/min.

### Test Results:

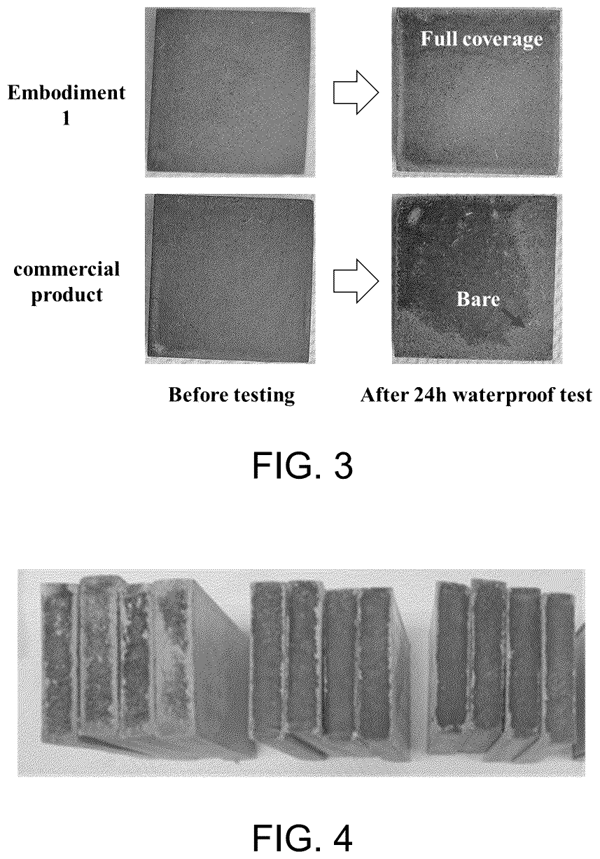

FIG. 3 shows the appearance (front views and side views, respectively) of the wax layers formed from the sealing composition of Embodiment 1 in Example 1 and from a commercial product (control) before and after the water immersion test.

It can be seen from FIG. 3 that the test sample coated with Embodiment 1 in Example 1 still shows a full coverage after water immersion for 24 hours, whereas the test sample coated with the commercial product presents bare appearance.

Test results of the sealing composition, comprising thickness swelling (%), water absorption (%), volume shrinkage (%), melting point (° C.) and coefficient of friction, are given in Table 2. The same tests were also performed on the commercial sealing composition, which is taken as control.

It can be seen from Table 2 that, as compared with commercial sealing composition product, the sealing compositions of the present disclosure show significantly lower thickness swelling, water absorption, volume shrinkage and coefficient of friction, and thus provide wood flooring products with improved waterproof performance and friction reduction.

TABLE 2
Test results of the sealing compositions.

| | Thickness | Water | Volume | Melting | |
|---|---|---|---|---|---|
| | swelling | absorption | shrinkage | point | Coefficient |
| | (%) | (%) | (%) | (° C.) | of friction |
| Blank | 12.9 | 80.3/1 d | / | / | 0.38 |
| Commercial | 9.1 | 27.6/1 d | 12 | 61.5 | 0.24 |
| sealing wax | | | | | |
| 1 | 0.2 | 1.4/1 d | 9 | 61.4 | 0.18 |
| | | 4.7/3 d | | | |
| | | 19.8/7 d | | | |
| 2 | 0.1 | 1.2/1 d | 8 | 60-65 | 0.2 |
| | | 9.8/7 d | | | |
| 3 | 0.2 | 0.3/1 d | 11 | 60-65 | 0.17 |
| 4 | / | 2.6/3 d | / | 60-65 | / |
| 5 | / | 2.7/3 d | / | 60-65 | / |
| 6 | / | 3.8/3 d | / | 60-65 | / |
| 7 | / | 14.6/3 d | / | 60-65 | / |
| 8 | / | 2.98/1 d | / | 60-65 | / |
| 9 | / | 1.85/1 d | / | 60-65 | / |
| 10 | / | 3.63/3 d | / | 60-65 | / |
| 11 | / | 1.47/3 d | / | 60-65 | / |
| 12 | / | 2.73/3 d | / | 60-65 | / |
| 13 | / | 2.64/3 d | / | 60-65 | / |
| 14 | / | 4.5/3 d | / | 60-65 | / |
| 15 | / | 33.3/7 d | / | 60-65 | / |
| 16 | / | 78.9/7 d | / | 60-65 | / |

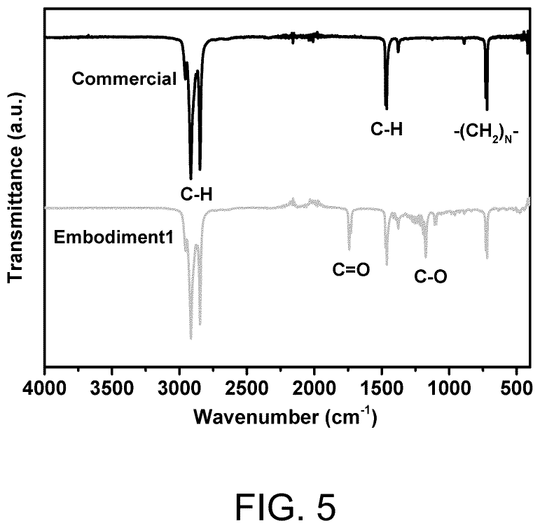

FIG. 5 shows Fourier transform infrared spectrograms of the sealing compositions of Embodiment 1 in Example 1 and a commercial product (control). It can be seen from FIG. 5 that the commercial sealing wax is composed of simple hydrocarbons, while the sealing wax compositions with added bio-based components exist with active functional groups.

### Example 3: Additional Test for Waterproof Durability Properties

Embodiments 1, 4 and 5 were further tested for waterproof durability. Particularly, the above-mentioned water absorption test was carried out except that the test samples were completely immersed into the container with ultrapure water for three days instead of 24 hours, and accordingly the water absorption rate was calculated after water immersion for 3 days.

FIG. 4 shows the appearance of the wax layer formed by the sealing compositions after the above water immersion test (side views, from left to right, Embodiments 1, 4, 5, respectively). It can be seen from FIG. 4 that the combination of structural stabilizers allows for better retention of the sealing composition.

The results are given in Table 3, which shows that the combined structural stabilizers can better improve the waterproof durability of the sealing composition.

TABLE 3
waterproof durability of the sealing compositions.

| Embodiments | Water absorption (%) |
|---|---|
| 1 | 4.7 |
| 4 | 2.6 |
| 5 | 2.7 |

What is claimed is:

1. A sealing composition, comprising following components based on a total weight of the sealing composition:
15%-55% of one or more paraffin waxes selected from a group consisting of a crude paraffin, semi-refined paraffin, all-refined paraffin, and mixtures thereof;
5%-50% of one or more bio-waxes selected from a group consisting of soy wax, beeswax, candelilla wax, rice bran wax, carnauba wax, and mixtures thereof;
10%-50% of one or more penetration aids selected from a group consisting of paraffin oil, isoparaffin, soybean oil, oleic acid, soft wax, and mixtures thereof; and
0-40% of one or more structural modifiers selected from a group consisting of a microcrystalline wax, petroleum resin, terpene resin, and mixtures thereof.

2. The composition according to claim 1, comprising the following components based on the total weight of the sealing composition:
30%-45% of the one or more paraffin waxes selected from the group consisting of the crude paraffin, the semi-refined paraffin, the all-refined paraffin, and the mixtures thereof;
15%-25% of the one or more bio-waxes selected from the group consisting of the soy wax, the beeswax, the candelilla wax, the rice bran wax, the carnauba wax, and the mixtures thereof; and
10%-40% of the one or more penetration aids selected from the group consisting of the paraffin oil, the isoparaffin, the soybean oil, the oleic acid, the soft wax, and the mixtures thereof; and
10%-25% of the one or more structural modifiers selected from the group consisting of the microcrystalline wax, the petroleum resin, the terpene resin, and the mixtures thereof.

3. The composition according to claim 1, comprising the following components based on the total weight of the sealing composition:
40%-45% of the one or more paraffin waxes selected from the group consisting of the crude paraffin, the semi-refined paraffin, the all-refined paraffin, and the mixtures thereof;
15%-20% of the one or more bio-waxes selected from the group consisting of the soy wax, the beeswax, the candelilla wax, the rice bran wax, the carnauba wax, and the mixtures thereof; and
25%-30% of the one or more penetration aids selected from the group consisting of the paraffin oil, the isoparaffin, the soybean oil, the oleic acid, the soft wax, and the mixtures thereof; and
10%-15% of the one or more structural modifiers selected from the group consisting of the microcrystalline wax, the petroleum resin, the terpene resin, and the mixtures thereof.

4. The composition according to claim 1, wherein the paraffin wax has a melting point from 50° C. to 65° C., and the bio-wax has a melting point from 55° C. to 85° C.

5. The composition according to claim 1, wherein the bio-wax is the soy wax and/or the beeswax.

6. The composition according to claim 1, wherein the penetration aid has a viscosity from 5 cSt to 10000 cSt and a boiling point of over 100° C.

7. The composition according to claim 1, wherein the structural modifier has a melting point from 50° C. to 105° C.

8. The composition according to claim 1, wherein, the structural modifier is a mixture of the microcrystalline wax and the terpene resin, or a mixture of the microcrystalline wax and the petroleum resin.

9. The composition according to claim 1, further comprising one or more functional additives.

10. The composition according to claim 1, wherein the sealing composition is in a solid state at room temperature, and has a melting point from 40° C. to 80° C.

11. The composition according to claim 1, wherein the sealing composition is prepared by melting the paraffin, the bio-wax, the penetration aid, the structural modifier, and optionally the functional additives at a temperature from 60° C. to 150° C. to a liquid state.

12. A wood product comprising a wood substrate and a wax layer formed from the sealing composition according to claim 1 on at least a part of a surface of the wood substrate.

13. The wood product of claim 12, wherein the wax layer is formed on an edge surface of the wood substrate.

14. The wood product of claim 12, wherein the wax layer is formed on a tongue-and-groove surface of the wood substrate.

15. The wood product of claim 12, wherein the sealing composition further penetrates the wood substrate.

16. The wood product of claim 12, wherein the wood product is trim, furniture, subflooring, wall coverings or wood floor.

17. A method for treating a wood substrate, comprising a step of applying the sealing composition according to claim 1 to at least a part of a surface of the wood substrate to form a wax layer.

18. The method according to claim 17, wherein the sealing composition is applied to an edge surface of the wood substrate to form the wax layer.

19. The method according to claim 17, wherein the sealing composition is applied to a tongue-and-groove surface of the wood substrate to form the wax layer.
